(19) United States
(12) Patent Application Publication
(10) Pub. No.: US 2023/0158937 A1
(43) Pub. Date: May 25, 2023

(54) Expeditious, Hygienic Drive Through Mobile Meal Service Methods and Systems

(71) Applicant: Magnate Holdings, LLC, Cheyenne, WY (US)

(72) Inventor: Victor J. Vinson, Colorado Springs, CO (US)

(21) Appl. No.: 17/918,059

(22) PCT Filed: Apr. 9, 2021
(86) PCT No.: PCT/US2021/026647

§ 371 Date: Oct. 10, 2022

Related U.S. Application Data
(60) Provisional application No. 63/007,857, filed on Apr. 9, 2020.

(51) Int. Cl. B60P 3/025

(52) U.S. Cl. CPC B60P 3/0257

(57) ABSTRACT

Embodiments of the present invention may provide a food service system and methods including, but not limited to: an ambulatory food service vehicle (1) having a food and drink preparation station (2); a removably attached interactive computer terminal (3) configured for customer ordering of food and drinks; an order pick-up window (5) in the ambulatory food service vehicle; and perhaps even an adaptable drive though lane system (4) configured to route customer vehicles (17) to a removably attached interactive computer terminal and thereafter to an order pick-up window (5) of the ambulatory food service vehicle.

### PRIORITY CLAIM

This is a PCT International Patent Application claiming priority to and the benefit of U.S. Provisional Application No. 63/007,857 filed Apr. 9, 2020, hereby incorporated by reference herein.

### FIELD OF THE INVENTION

Embodiments of the present invention may include methods and systems for drive through mobile meal service. A vehicle, such as a food trailer, or the like may be designed to allow customers to order and expeditiously pick up meals that are hygienic while staying in their vehicles.

### BACKGROUND OF THE INVENTION

Food trucks and/or trailers may be a large motorized vehicle such as a van or a trailer that can be equipped to cook, prepare, serve, and even sell food. Food trucks have become popular around the world and may even serve gourmet cuisine or a variety of specialties and ethnic menus. Typically, food trucks have a window where customers can walk up to, order, and pick up their meals. It is desirable to provide a mobile meal service where customers can stay in their vehicles and combine the ability to have a mobile food truck and/or food trailer or the like that can also be a drive through. It is also desirable to provide a mobile meal service where there is only minimal contact between the customer and the food preparer perhaps to avoid transmission of germs and viruses.

### SUMMARY OF THE INVENTION

The present invention includes a variety of aspects, which may be selected in different combinations based upon the particular application or needs to be addressed. In various embodiments, the invention may include a mobile meal service that can provide drive through services.

One goal of the present invention may include providing expeditious output of food items from the order to delivery of the food to the customer.

Another goal of the present invention may include providing a hygienic process so that there may be minimal contact between the customer and the food handler.

Yet another goal of the present invention may include providing an ambulatory food service vehicle that can be moved from one location to another while still allowing customer to order and pick up food in their own vehicles.

Naturally, further objects, goals and embodiments of the inventions are disclosed throughout other areas of the specification, claims, and drawings.

### BRIEF DESCRIPTION OF THE DRAWINGS

FIG. 1 shows a non-limiting example of an ambulatory food service vehicle with an adaptable drive through lane system in accordance with some embodiments of the present invention.

FIG. 2 shows a non-limiting example of an ambulatory food service vehicle with an adaptable drive through lane system in accordance with some embodiments of the present invention.

FIG. 3 shows a non-limiting example of a side view of an ambulatory food service vehicle and an order pick-up window in accordance with some embodiments of the present invention.

FIG. 4 shows a non-limiting example of a side view of an ambulatory food service vehicle with an order pick-up window and car barriers in accordance with some embodiments of the present invention.

FIG. 5 shows a non-limiting example of a side view of an ambulatory food service vehicle with a removably attached interactive computer terminal and car barriers in accordance with some embodiments of the present invention.

FIG. 6 shows a non-limiting example of an exterior of an ambulatory food service vehicle in accordance with some embodiments of the present invention.

FIG. 7 shows a non-limiting example of an exterior of an ambulatory food service vehicle in accordance with some embodiments of the present invention.

FIG. 8 shows a non-limiting example of an interior curb side layout of an ambulatory food service vehicle in accordance with some embodiments of the present invention.

FIG. 9 shows a non-limiting example of an interior street side layout of an ambulatory food service vehicle in accordance with some embodiments of the present invention.

FIG. 10 shows a non-limiting example of an inside layout of an ambulatory food service vehicle in accordance with some embodiments of the present invention.

FIG. 11 shows a non-limiting example of a wall frame for an ambulatory food service vehicle in accordance with some embodiments of the present invention.

FIG. 12 shows a non-limiting example of a robotic arm attached to a removably attached interactive computer terminal in accordance with some embodiments of the present invention.

FIG. 13 shows a non-limiting example of a sanitization system in accordance with some embodiments of the present invention.

FIG. 14 shows a non-limiting example of restaurant to an ambulatory food service vehicle system in accordance with some embodiments of the present invention.

### DETAILED DESCRIPTION OF THE INVENTIONS

It should be understood that the present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

Embodiments of the present invention may include a food service system comprising an ambulatory food service vehicle having a food and drink preparation station; a removably attached interactive computer terminal of said ambulatory food service vehicle configured for customer ordering of food and drinks from said ambulatory food service vehicle; an order pick-up window in said ambulatory food service vehicle; and perhaps even an adaptable drive though lane system configured to route customer vehicles to said removably attached interactive computer terminal and thereafter to said order pick-up window of said ambulatory food service vehicle. It may include a method of providing mobile food services comprising the steps of providing an ambulatory food service vehicle having a food and drink preparation station; parking said ambulatory food service vehicle at a location; providing a removably attached interactive computer terminal on said ambulatory food service vehicle; routing customer vehicles to said removably attached interactive computer terminal with an adaptable drive though lane system; allowing a customer in a vehicle to drive up to and order food and drinks from said removably attached interactive computer terminal; sending said order to said ambulatory food service vehicle; routing said customer vehicle from said removably attached interactive computer terminal to an order pick-up window in said ambulatory food service vehicle with said adaptable drive though lane system; and perhaps even providing said order to said customer in said customer vehicle at said order pick-up window of said ambulatory food service vehicle.

The present invention may provide, in some embodiments, an ambulatory food service vehicle (1) which may have a food and drink preparation station (2). An ambulatory food service vehicle may be any kind of vehicle that can move from place to place and that may not be stationary. It may be a trailer, a truck, a van, or any other type of vehicle, which may be mobile and may provide capabilities for a customer to order, pay, and receive food items while remaining in their vehicle perhaps with minimal contact between the customer and the people in the mobile vehicle. Any type of vehicle may be used and all are meant to be included in this disclosure.

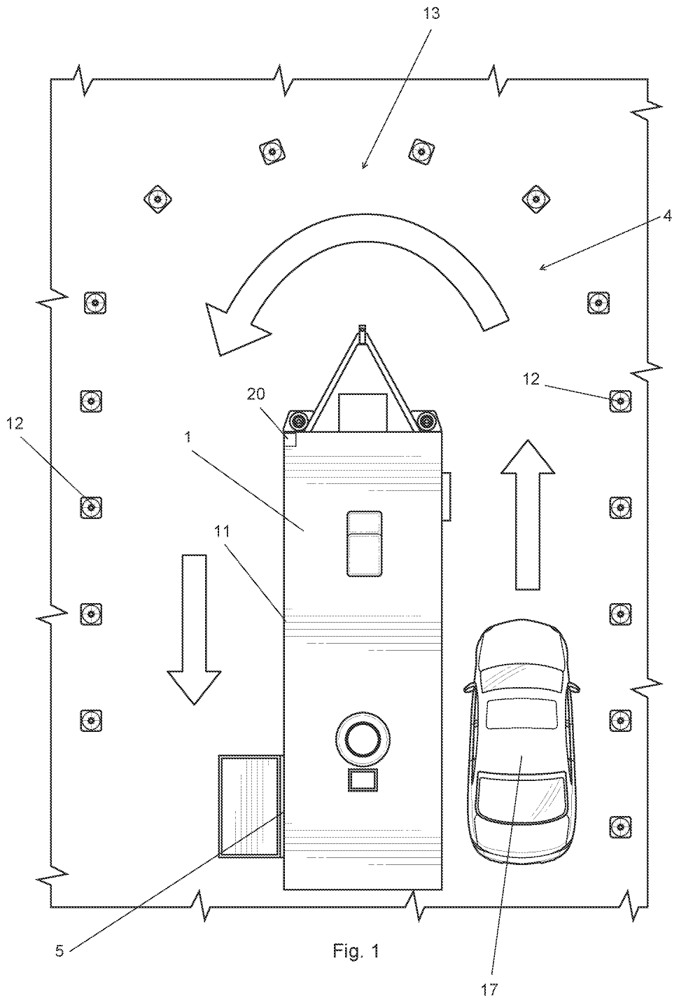

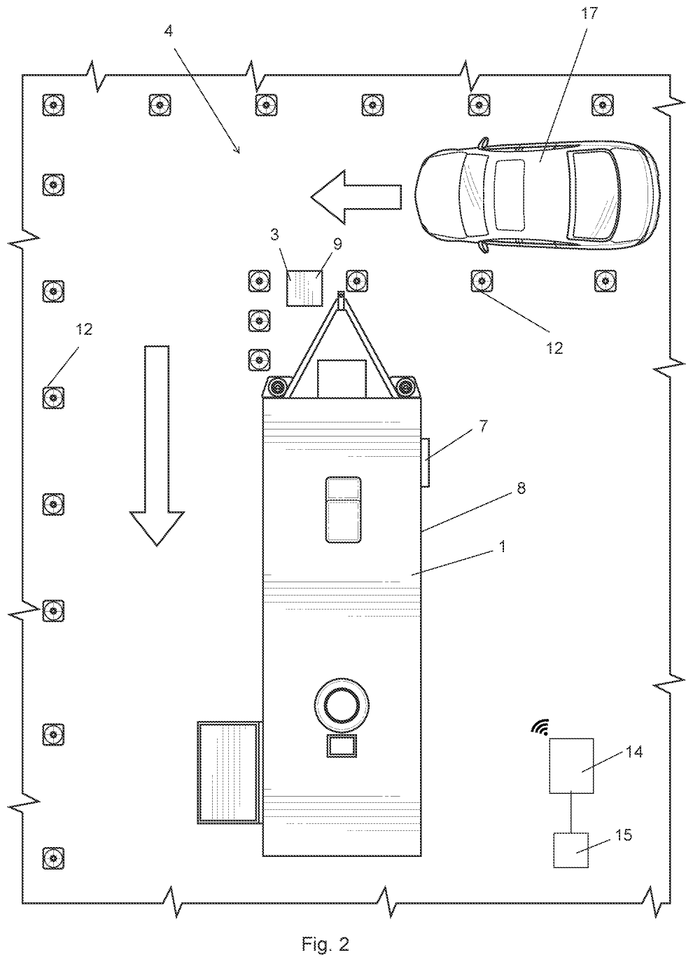

Embodiments of the present invention may provide a streamlined process where drive-through food services may be made so that a customer may be able to order and pay for their food orders perhaps at the same time via computer interactive devices and may be able to drive up and pick up their food order with very little to no contact between the food trailer worker and the customer and even at a very fast rate. A removably attached interactive computer terminal (3) may be part of an ambulatory food service vehicle and may be configured for customer ordering of food and drinks from a vehicle. An adaptable drive though lane system (4) may be used with the ambulatory food service vehicle perhaps to route customer vehicles (17) to the removably attached interactive computer terminal and thereafter to an order pick-up window (5). An adaptable drive through lane system (4) may direct a customer vehicle (17) to drive up and order food and drinks from an interactive computer terminal and then to pick up their order as may be understood from FIGS. 1 and 2.

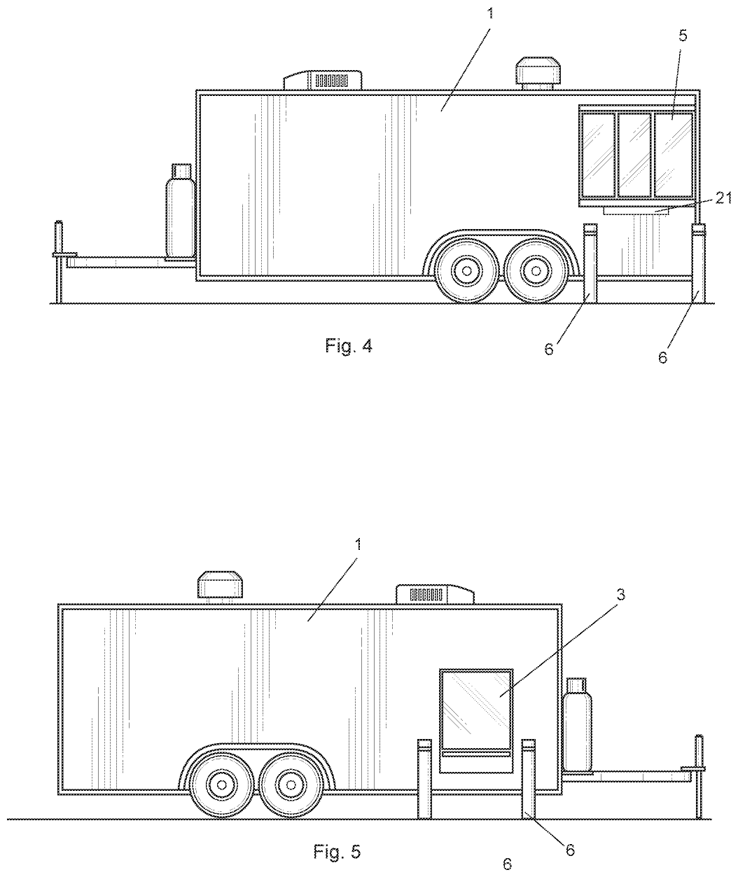

A customer may order food and drinks from an ambulatory food service vehicle perhaps with a removably attached interactive computer terminal (3). An interactive computer terminal may be a touchscreen, kiosk, computer monitor, or the like and can be detached from or even attached to a trailer. Other embodiments may include a non-touchscreen perhaps with a cursor device and/or a touchscreen perhaps made for a stylus input. Any type of digital communication perhaps with an interactive computer terminal available for public use may be used. In one embodiment, an interactive computer terminal may be removable attached to a side of a vehicle. It may be contained in a cabinet (7) perhaps located on an external side (8) of a trailer and may be removed out of a cabinet and placed in a location away (9) from a vehicle such as shown in FIG. 2. A terminal may be moved away from a vehicle perhaps depending on the location of the trailer and the desired flow of traffic. In some embodiments, a car barrier (6) can be placed near an interactive computer terminal and/or even a drive-up window which may protect the terminal and vehicle perhaps as shown in FIGS. 4 and 5. These may be portable posts, cement barriers, cement blocks or other barriers and may even guide vehicles to stop at certain points for ordering and food pick up. A terminal (3) may include a credit card terminal, googly pay, apple pay, or the like. A terminal (3) may include an intercom, a touch screen or the like. In some embodiments, a second interactive computer terminal may be used. A second interactive computer terminal may be used for backup or eve for situations where it may be desired to have a second ordering drive through lane. This can be accomplished with an adaptable drive through lane system as discussed herein. All menu items (perhaps about six to eight items or more) may be displayed on an interactive computer terminal. A customer can select the desired item or items, then if other options may be provided, a user may select a side order and even a drink perhaps from a sub screen. A user may then pay for the order where a credit card or other payment method can be authorized at the terminal. In some embodiments, cash may be selected and can be paid at the pick-up window. A credit card reader could be enabled to read and even process magnetic-striped, or even chipped, gift cards perhaps that a food trailer proprietor may sell from time to time for pre-charged dollar amounts. A cash reader may also be installed on or even next to a Kiosk for those preferring to pay cash.

An interactive computer terminal (3) may be located on an opposite side (10) from an order pick-up window of a vehicle such as shown in FIG. 1. In other embodiments, an interactive computer terminal may be located on a same side (11) as an order pick-up window. After a customer may place an order from their vehicle or perhaps enter their order code, the customer may pull forward, perhaps make a U-turn or other turning around so that the user can have access to the other side of a trailer from the driver's side of their vehicle as may be understood in FIGS. 1 and 2. A customer may be guided with an adaptable drive through lane system (4) which may include cones (12), orange cones, signage, or other traffic guides placed on the ground to guide customer vehicles. As such, an adaptable drive through lane system may provide a U-turn lane (13) from a terminal to an order pick-up window as shown in FIG. 1. A user may pull up to an order pick-up window and receive their food order and may even pay cash for the meal if needed. A window of a vehicle may be custom made and may accommodate different size customer vehicles. In some embodiments, a window may need to be lower on a vehicle to accommodate lower vehicles or the like. A vehicle may be able to receive several orders that have been placed by a user and start preparing while the users make their U-turns and wait for their food pick-up. In some embodiments, an order pick-up time may be less than about three minutes from a time an order is placed from an interactive computer terminal to the time an order is ready at an order pick-up window.

In some embodiments, a system may provide that an interactive computer terminal be installed on a food service vehicle perhaps in an out-cabinet on a corner of a vehicle, and may be used for “walk-up” customer traffic or even higher-than-normal drive through ordering (such as from a pickup truck). Alternatively, a food service vehicle may be designed so that the interactive computer terminal can be snapped out of its holding cabinet, placed on the ground, and wheeled to an appropriate location for the “drive thru” lane supporting regular in-vehicle customers. Further, depending on the location of the food service vehicle, local traffic conditions, safety regulations and the like, an interactive computer terminal can be wheeled to the opposite side (meaning same side as the pick-up window) to support further types of “walk up” customers (e.g., such as those lined up on a sidewalk perhaps while a food service vehicle may be parallel parked against a street curb.

Embodiments of the present invention may provide remote ordering system (14) perhaps where a customer can pre-order food via a web-based application, a website, an app, or the like and even pay for the order remotely for later pick-up at a food trailer. When an order has been placed, a customer may receive an order code (15) or other identifying mark in which a customer can provide when picking up an order. Once a remote order may be placed, a food truck may start assembling the food. As but one non-limiting example, a customer may drive up to ambulatory food service vehicle and enter their order code at a terminal. A terminal may recognize the code from the remote order and the order may be picked up from the food trailer.

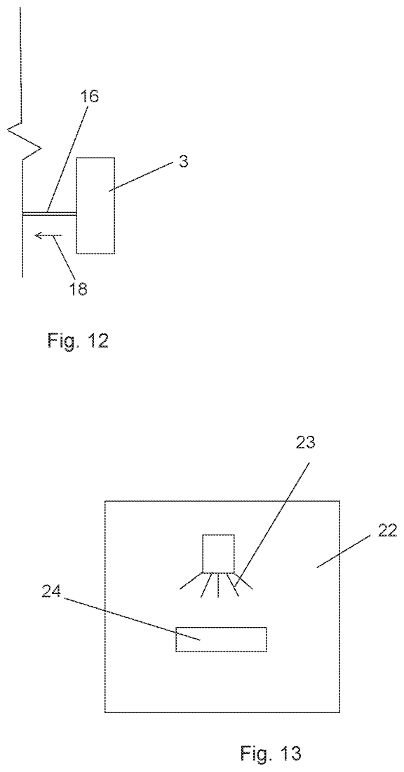

In some embodiments, the present invention may include a robotic arm (16), perhaps even a sensor-enabled movable robotic arm, that could be connected to an interactive computer terminal and may even auto-sense an arrival of a new customer into a drive-through space perhaps via an auto-sense customer vehicle arrival feature such as shown in FIG. 12. A robotic arm or the like may move an interactive computer terminal closer to a customer vehicle (17) perhaps to a position for customer use, thus perhaps auto-adjusting to the appropriate vehicle window height, position, and even orientation, or the like. An arm could also auto-retract when a customer drives away to provide an auto-retraction feature (18), perhaps when a service day may be completed, for storage and even protection, or the like.

An ambulatory food service vehicle may be parked in one location and may be left there or may be moved to various locations. An order pick-up window (5) may be located on one side of a food service vehicle. An order pick-up window may be designed to allow food to be easily passed to waiting customers in vehicles and the like. It is noted that an ambulatory food service vehicle may accommodate customers that walk up to the vehicle on foot and not by vehicle.

Embodiments of the present invention may provide a security system (20) for a food service system. A security system may include exterior and even interior vehicle security cameras. It may be an integrated security system perhaps to survey and even video a complete exterior of an ambulatory food service vehicle and its surroundings. For example, a 360 degree view may be accomplished by placing at least four roof-top cams on each corner of the vehicle or even at other appropriate locations. A security system may include at least two cameras inside perhaps showing forward and backward views. A security system can capture full real-time video feeds or can optionally be armed or disarmed either manually or via pre-programmed schedules. A system may be motion-detectable, can capture night video, and can capture audio. A security system may broadcast alerts to the owners of the food service vehicle which may allow two-way audio, playback of video, and system controls, perhaps all remotely.

In embodiments, the present invention may provide a hygienic, non-human-touch type of drive through. This may include a contactless sliding drawer (21) at an order pick-up window. This may be similar to a bank drive-through where perhaps a drawer may slide in and out, thus minimizing human-to-human contact for purposes of extra “social distancing” and hygiene to minimize spread of germs and viruses. A sliding drawer may be located underneath an order pick-up window, which may slide in and out so that food can be delivered to the customer on a contact-less basis, perhaps to meet anti-Covid or other hygiene/safety concerns.

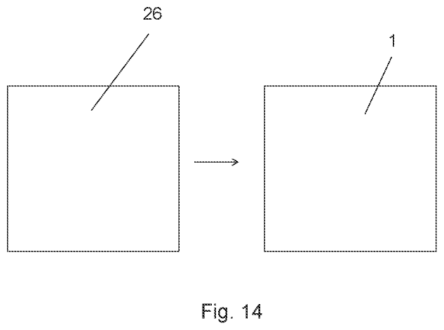

Embodiments of the present invention may provide a sanitization system (22) in the ambulatory food service vehicle such as shown in FIG. 13. This may include air and surface sanitization capabilities to kill germs, bacteria, viruses, spores, and other unsanitary conditions—perhaps in the ambient air within the trailer and on all available internal surfaces. The sanitization system can be operated simultaneously with a human operator in the trailer or during down time. A sanitization system may include a sanitizing mist or even combinations of auto-spray-sanitizing mist devices could be used internally, perhaps to decontaminate a trailer overnight, during rest periods, or the like. Other systems may include manual antiseptic wipe downs, UV sterilizing light devices, Ozone machines, or the like which can decontaminate the interiors of all forms of germs, viruses, mold, and mildew, or the like. A UV light device or other sanitizing methods may be built-in and may sterilize the packaging or containers in which the food may be placed. In some embodiments, food may already by sterile in a food trailer. A food worker may not ever touch the food items; however, a food worker may touch the packaging that the food items are placed and which may have contaminants thereon or a food worker may even contaminate the packaging. Thus, the food package (24) having the food therein may be sterilized such as with a UV light device, sanitizing mist (23), or the like perhaps in as little as about 12 seconds. A customer may then take the sterilized packaged food for consumption.

The present invention may provide, in embodiments, foods that can be sold and delivered in individual, self-sealed protective containers, for customers to take home or to the office. This feature could further minimize community spread of viruses and germs, since the food could be sterilized perhaps by high-heat cooking in a central kitchen, then immediately placed, while hot, into specialty individual-serving-sized containers, then sealed, and perhaps even then frozen. Once loaded up into a trailer, containers could be spray sanitized on the outside, and perhaps even a decontaminated container could be sent through one or more variations of the pass-through window directly to the customer, perhaps providing a high level of sanitized food delivery.

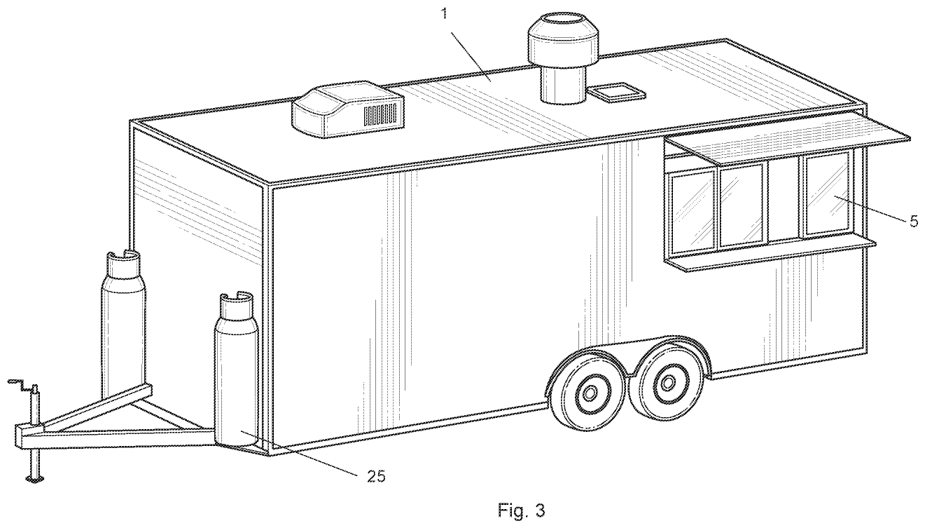

An ambulatory food service vehicle may need a power supply (25) perhaps for refrigeration, freezing, air-conditioning, heat, powering sanitization, or the like such as shown in FIG. 3. Power may be supplied with electricity, with externally mounted propane tanks, rechargeable batteries, or the like. Batteries may be used at night and may be charged during the day perhaps by a generator, solar power, or the like. A generator may be a propane generator. Propane may run a generator and may even run stoves for a food trailer. Batteries may be used to power a refrigerator, freezer or the like at night.

Embodiments of the present invention may provide a customized trailer for any type of food such as authentic, sit down restaurant quality Cajun food experience which may be delivered through a fast mobile, drive-through only, trailer platform perhaps open year-round.

A food service vehicle may provide a specific type of food, for example, authentic Louisiana food. A food service system may have a commissary kitchen such as a restaurant (26) perhaps to make base foods in bulk for distribution to food service vehicles such as cooking trailers such as shown in FIG. 14. In some embodiments, menu items may be made in large batches perhaps at a central kitchen location, may be frozen before thawing, reheating, and serving. This may ensure consistency and even protect recipes from duplication. Menu items in a food trailer may be grilled and even kept hot in chafing dishes; may be deep-fried perhaps at about 90% and finished when an order is placed; and may even be heated and kept hot in chafing dish. Each item in a trailer may have its own prep station perhaps allowing each item to have its own space and time.

In some embodiments, the present invention may provide an expansion of a restaurant to a food trailer. A restaurant may have a limited amount of top food items, perhaps about six items or more, that may be their best selling food. These limited items may be used with ambulatory food service vehicle so that the mobile food service may offer these top items. A kitchen inside a food trailer may be streamlined such that each item may be in an assembly line to make food preparation as fast as possible.

Embodiments of the present invention may provide low startup costs. With a high demand for good food on the go, the food truck & trailer business may be a fast-growing channel in the foodservice industry. In some embodiments, a food trailer may provide an authentic food experience perhaps delivered through a mobile, drive-through only, trailer platform for those on the go in a fast-paced world. An advantage to mobile trailers may provide the ability to locate to another site perhaps if a location does not meet expectations.

Embodiments of the present invention may include a mobile trailer platform perhaps enabling a better drive through experience faster than the typical high counter food truck; drive through ordering kiosks that perhaps with a delivery time under about three minutes or two minutes (e.g., an average truck wait time may be about 15 to about 20 minutes); year-round operations perhaps where in the past, bad weather days could shut down a food truck; and perhaps even large portioned high quality sit down restaurant food in a fast-food operation; or the like.

Inside an ambulatory food service vehicle, storage space may be maximized perhaps with large under counter cabinets and even shelves. An ambulatory food service vehicle may be designed to maximize service life. Equipment may be chosen for a superb balance of longevity, ease of operation, and even maintenance support, or the like. A food service vehicle may include at least one bathroom (27) for the employees. In some embodiments, a food service vehicle may be about 20 feet in length and may not have a bathroom; in other embodiments, a food service vehicle may be about 24 feet in length and may have a bathroom. Of course, any size trailer may be used and all sizes are meant to be included in this disclosure.

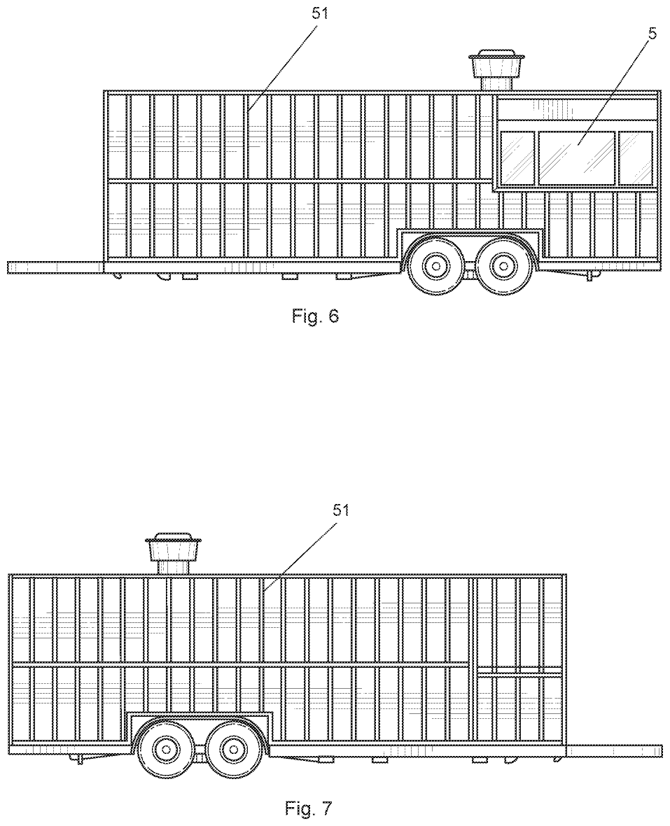

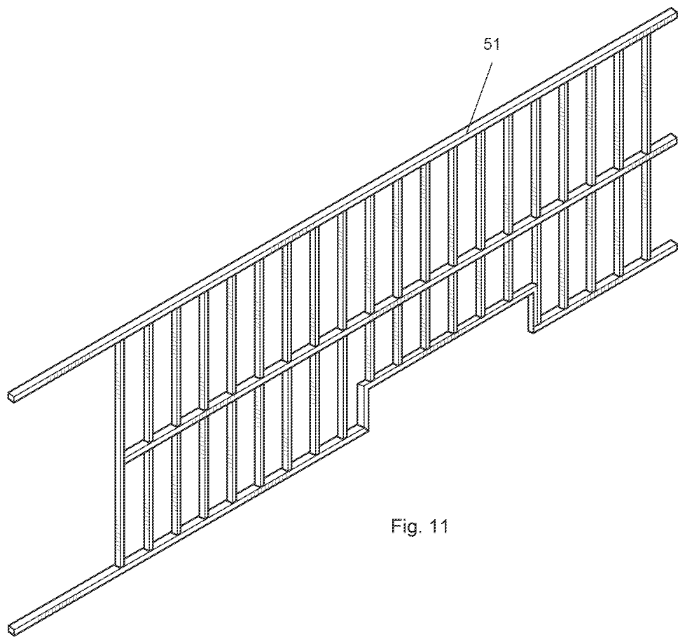

A wall frame (51) for an ambulatory food service vehicle may be fabricated perhaps from custom formed, interlocking, steel parts that may provide high strength and minimizing overall tare weight. Walls may be widened to provide about 8 feet wide by about 24 feet long of interior space in a food service vehicle. FIGS. 6, 7, and 11 show non-limiting examples of frames. While non-limiting examples of sizes are included in the figures, any sizing may be used and all are meant to be included in this disclosure.

Embodiments of the present invention may provide a fully equipped kitchen for a mobile food service vehicle that may be custom designed. Some trailers may include deep fryers, some may not. Trailers may be designed so that each menu item may be in a sterile environment and that a chef or food handler inside a trailer need not touch the menu items. In other embodiments, a trailer can be designed so that there is very little to no contact between the customer and the food handler.

A non-limiting example of an ambulatory food service vehicle, perhaps called a concession trailer, may include but is not limited to: about 8.5 feet by about 24 feet trailer; a heavy duty and even custom formed steel frame; a range such as one (1) 36 inch, 6 burner, liquid propane, range with a 30 inch oven; fryers, a griddle such as one (1) 24″, liquid propane, griddle on 30″D×24″W equipment stand (Cooking Performance Group); a fryer such as two (2) 40 LB, liquid propane fryers (Avantco); a steam table such as one (1) 60″, 4 tray, sealed steam table (Advance Tabco); a refrigerator such as one (1) 19 Cu FT. refrigerator (Avantco); a freezer such as one (1) 19 Cu FT. freezer (Avantco); a refrigerated preparation station such as one (1) 36″ refrigerated sandwich prep station (Avantco); a water heater such as one (1) liquid propane, On-Demand, water heater (Truma); a hand wash station such as two (2) hand wash stations perhaps including a sink, soap dispenser, and even a towel dispenser (Advance Tabco); one (1) 58″ 3 compartment sink with 2 drainboards (Regency); a water tank fill port such as one (1) 50 gallon fresh water tank with exterior fill port; a water tank drain such as two (2) 30 gallon waste water tanks with 3″ RV style drain; a worktop table such as one (1) 24″×24″ stainless steel worktop table with an undershelf (Regency);countertops with cabinets below such as one (1) 25″×84″ stainless steel countertop with cabinets below (Advance Tabco); one (1) 36″×84″ dual opening service window, manual open and self-close (Ready Access); a vent hood with a fire suppression system such as one (1) 144″×30″ exhaust only vent hood with fire suppression system, 2376 CFM; a thermostat such as one (1) 15,000 BTU heat pump and wall mount thermostat (Dometic); two (2) 100# propane tanks with plumbing to equipment (Worthington); 5,200 LB rubber torsion axle with electric brakes; 5,200 LB rubber torsion axle with electric brakes; 16″ steel, electro-coated silver, “modular” style, 6 lugs on 5.5″ bolt circle wheels; ST235/80R16 load range E Good Year radial tires; a spare tire; a spare wheel; “Teardrop” style fender flares; 12V electrical for clearance, signal, and brake lighting with 7-pin connection standard; LED lights; flood lights perhaps to illuminate signage from above; 7,000 Watt Onan LP Generator; a power cable such as 50 Amp Shore power cable; power circuits such as transfer switch; 100 Amp Service Panel with separate circuits for all equipment; propane tanks such as two (2) 100 lb. propane tanks; a remote propane fill port; propane flow regulator; dedicated propane shut offs perhaps for each tank, generator, interior, and each appliance; entire frame and underfloor coated with rubberized lining; exterior skin to be 0.040″ White Aluminum paneling w/ smooth, rivetless bonding; interior skin to be 0.040″ White Aluminum Paneling over ⅜″ Plywood; brushed stainless steel to be used below vent hood; rubber tread flooring; 1″ marine grade plywood; an underside of plywood may have a rubberized coating applied for water proofing; tankless, RV-style, toilet; dedicated hand washing station located inside lavatory; bi-fold door opens into lavatory to keep kitchen area clear; trailers conform to all Federal Motor Safety Standards in effect on the date of manufacture; and perhaps even a second 15,000 BTU Heat Pump (A/C+Heat); any brand, any quantity, any combination or permutation thereof, or the like.

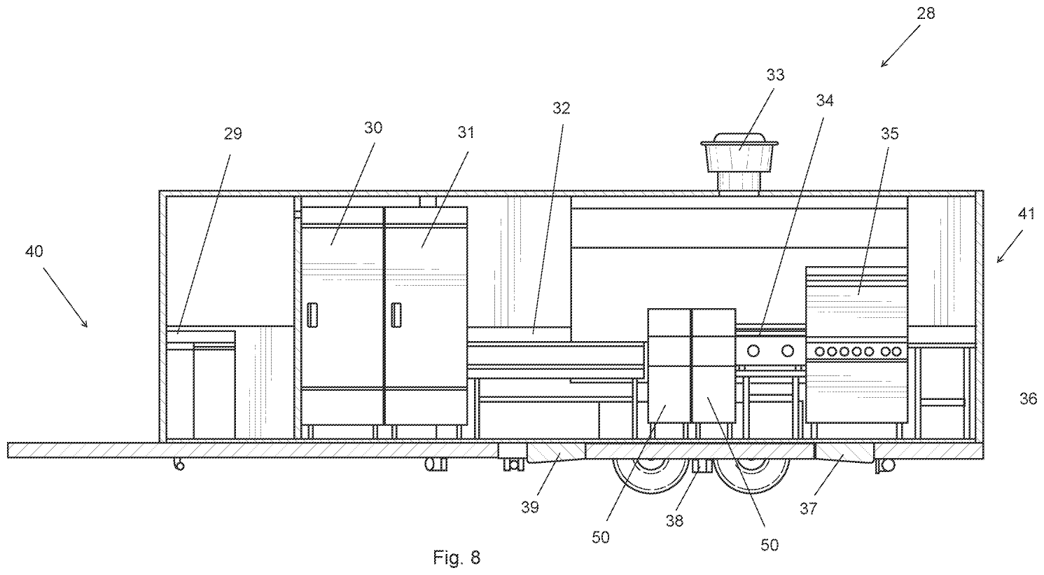

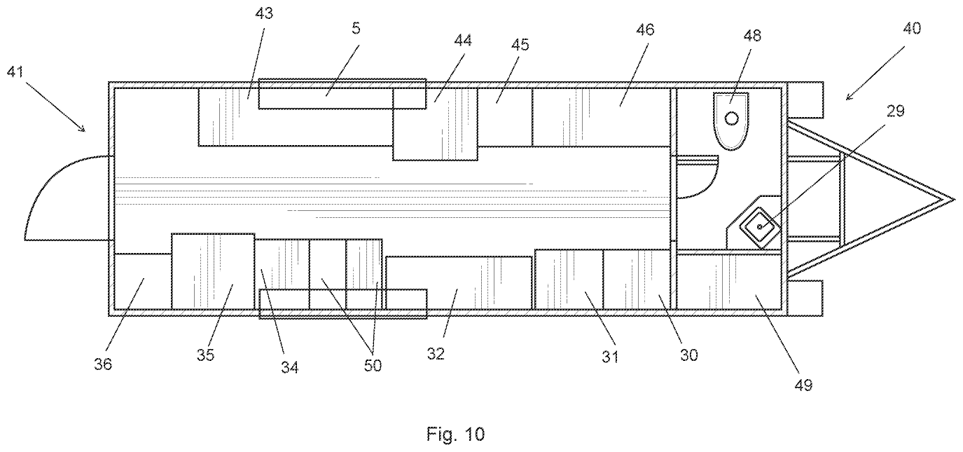

Embodiments of the present invention may provide an interior of a mobile trailer which may include, but is not limited to: a storage compartment (49); a hand wash sink in a bathroom; a 19 cu foot refrigerator; a 19 cu foot freezer; a 4 pan steam table; a 30 inch by 10 foot exhaust hood with filters and a grease trap; two fryers; a 24 inch griddle on a 24 inch by 30 inch equipment stand; a 36 inch 6-burner stove with oven; a 24 inch by 24 inch preparation table with an undershelf; a 30 gallon holding tank for a kitchen; a curb side waste outlet with separate gate valves for each tank; and perhaps even a 30 gallon holding tank for a bathroom; any size; any combination or permutation thereof, or the like. An interior curb side layout (28) from a front (40) of a vehicle to a back (41) of a vehicle may include: a hand wash sink in a bathroom (29), a 19 cubic foot refrigerator (30), a 19 cubic foot freezer (31), a 4 pan steam table (32), a 30 inch by 10 foot exhaust hood with filters and a grease trap (33), two fryers (50), a 24 inch griddle on a 24 inch by 30 inch equipment stand (34), a 36 inch 6-burner stove with oven (35), a 24 inch by 24 inch preparation table with an undershelf (36), a 30 gallon holding tank (37) for a kitchen under said vehicle, a curb side waste outlet with separate gate valves for each tank (38) located under said vehicle, and perhaps even a 30 gallon holding tank for a bathroom (39) located under said vehicle as shown in FIGS. 8 and 10.

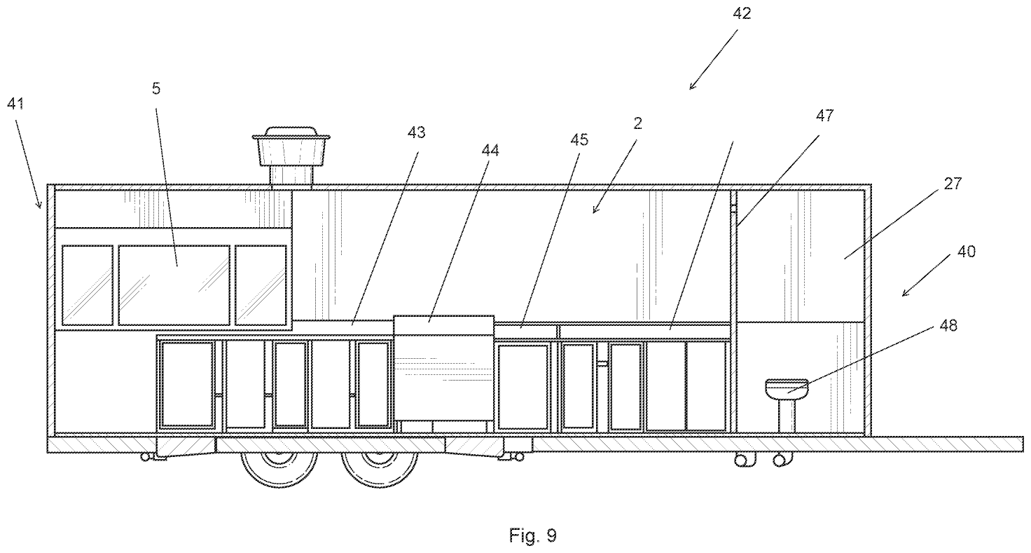

Embodiments of the present invention may provide an interior of a mobile trailer which may include, but is not limited to: an 84 inch service window with two manual open, self-close sections; an 84 inch counter with cabinets below; a 36 inch refrigerated sandwich prep station; a hand wash station with a cabinet below; a three bay sink with drain boards with cabinets below; a bi-fold bathroom door; a porcelain RV toilet; any size; any combination or permutation thereof, or the like. An ambulatory food service vehicle may provide an interior street side layout (42) from a back (41) of a vehicle to a front (40): an 84 inch service window; 84 inch counter with cabinets below (43); a 36 inch refrigerated sandwich prep station (44); a hand wash station with a cabinet below (45); a three bay sink with drain boards with cabinets below (46); a bi-fold bathroom door (47); and perhaps even a porcelain RV toilet (48). An order pick up window (5) may be an 84 inch service window perhaps with two manual open, self-close sections as shown in FIGS. 9 and 10.

While the invention has been described in connection with some preferred embodiments, it is not intended to limit the scope of the invention to the particular form set forth, but on the contrary, it is intended to cover such alternatives, modifications, and equivalents as may be included within the spirit and scope of the invention as defined by the statements of inventions. Examples of alternative claims may include:

1. A food service system comprising:
an ambulatory food service vehicle having a food and drink preparation station;
a removably attached interactive computer terminal of said ambulatory food service vehicle configured for customer ordering of food and drinks from said ambulatory food service vehicle;
an order pick-up window in said ambulatory food service vehicle; and
an adaptable drive though lane system configured to route customer vehicles to said removably attached interactive computer terminal and thereafter to said order pick-up window of said ambulatory food service vehicle.
   2. The food service system as described in clause 1 or any other clause wherein said removably attached interactive computer terminal is located on an opposite side from said order pick-up window of said ambulatory food service vehicle.
   3. The food service system as described in clause 1 or any other clause wherein said removably attached interactive computer terminal is removed from said ambulatory food service vehicle and placed in a location away from said ambulatory food service vehicle.
   4. The food service system as described in clause 1 or any other clause and further comprising a car barrier located near said removably attached interactive computer terminal.
   5. The food service system as described in clause 1 or any other clause and further comprising a car barrier located near said order pick-up window.
   6. The food service system as described in clause 4 or 5 or any other clause wherein said car barrier comprises a portable post.
   7. The food service system as described in clause 1 or any other clause and further comprising a cabinet located on an external side of said ambulatory food service vehicle configured to contain said removably attached interactive computer terminal.
   8. The food service system as described in clause 1 or any other clause wherein said removably attached interactive computer terminal is located on a same side as said order pick-up window of said ambulatory food service vehicle.
   9. The food service system as described in clause 1 or any other clause wherein said removably attached interactive computer terminal comprises a credit card terminal and an intercom.
   10. The food service system as described in clause 1 or any other clause and further comprising a second interactive computer terminal.
   11. The food service system as described in clause 1 or any other clause and further comprising a remote ordering system.
   12. The food service system as described in clause 11 or any other clause wherein said remote ordering system comprises a web-based application and an order code to be entered at said removably attached interactive computer terminal.
   13. The food service system as described in clause 1 or any other clause wherein said adaptable drive though lane system comprises cones placed to guide customer vehicles.
   14. The food service system as described in claim 1 or any other clause wherein said adaptable drive through lane comprises a U-turn lane from said removably attached interactive computer terminal to said order pick-up window.
   15. The food service system as described in clause 1 or any other clause wherein an order pick-up time is less than about three minutes from a time an order is placed from said removably attached interactive computer terminal to the time an order is ready at said order pick-up window.
   16. The food service system as described in clause 1 or any other clause and further comprising a movable robotic arm connected to said removably attached interactive computer terminal configured to move said removably attached interactive computer terminal closer to said customer vehicle.
   17. The food service system as described in clause 16 or any other clause wherein said movable robotic arm comprises an auto-retraction feature.
   18. The food service system as described in clause 16 or any other clause wherein said movable robotic arm comprises an auto-sense customer vehicle arrival feature.
   19. The food service system as described in clause 1 or any other clause and further comprising a security system.
   20. The food service system as described in clause 19 or any other clause wherein said security system comprises exterior and interior security cameras.
   21. The food service system as described in clause 1 or any other clause and further comprising a contactless sliding drawer at said order pick-up window.
   22. The food service system as described in clause 1 or any other clause and further comprising a sanitization system in said ambulatory food service vehicle.
   23. The food service system as described in clause 22 or any other clause wherein said sanitization system comprises a sanitizing mist.
   24. The food service system as described in clause 22 or any other clause wherein said sanitization system comprises sanitization of the food package.
   25. The food service system as described in clause 1 or any other clause and further comprising a power supply to said ambulatory food service vehicle chosen from externally mounted propane tanks and rechargeable batteries.
   26. The food service system as described in clause 1 or any other clause wherein said ambulatory food service vehicle has an internal space of about 8 feet wide by about 24 feet long.
   27. The food service system as described in clause 1 or any other clause wherein said ambulatory food service vehicle comprises a bathroom.
   28. The food service system as described in clause 1 or any other clause wherein said food prepared in said ambulatory food service vehicle comprises food prepared at a restaurant and distributed to said ambulatory food service vehicle.
   29. The food service system as described in clause 28 or any other clause wherein said food prepared in said ambulatory food service vehicle has been previously frozen and thawed.
   30. The food service system as described in clause 28 or any other clause wherein said food prepared in said ambulatory food service vehicle comprises best selling food from said restaurant.
   31. The food service system as described in clause 1 or any other clause wherein said ambulatory food service vehicle comprises an element chosen from a range, griddle, fryer, steam table, refrigerator, freezer, refrigerated preparation station, water heater, hand wash station, towel dispenser, sink, soap dispenser, water tank fill port, water tank drain, worktop table, countertops with cabinets below, vent hood with a fire suppression system, thermostat, flood lights, power cable, power circuits, propane tanks, propane fill port, propane flow regulator, and any combination or permutation thereof.
   32. The food service system as described in clause 1 or any other clause wherein said ambulatory food service vehicle comprises an interior curb side layout from a front of a vehicle to a back of a vehicle: a hand wash sink in a bathroom, a 19 cubic foot refrigerator, a 19 cubic foot freezer, a 4 pan steam table, a 30 inch by 10 foot exhaust hood with filters and a grease trap, two fryers, a 24 inch griddle on a 24 inch by 30 inch equipment stand, a 36 inch 6-burner stove with oven, a 24 inch by 24 inch preparation table with an undershelf, a 30 gallon holding tank for a kitchen under said vehicle, a curb side waste outlet with separate gate valves for each tank located under said vehicle, and a 30 gallon holding tank for a bathroom located under said vehicle.
   33. The food service system as described in clause 1 or any other clause wherein said ambulatory food service vehicle comprises an interior street side layout from a back of a vehicle to a front: an 84 inch service window; 84 inch counter with cabinets below; a 36 inch refrigerated sandwich prep station; a hand wash station with a cabinet below; a three bay sink with drain boards with cabinets below; a bi-fold bathroom door; and a porcelain RV toilet.
   34. The food service system as described in clause 1 or any other clause wherein said order pick-up window comprises an 84 inch service window with two manual open, self-close sections.
   35. A method of providing mobile food services comprising the steps of:
providing an ambulatory food service vehicle having a food and drink preparation station;
parking said ambulatory food service vehicle at a location;
providing a removably attached interactive computer terminal on said ambulatory food service vehicle;
routing customer vehicles to said removably attached interactive computer terminal with an adaptable drive though lane system;
allowing a customer in a vehicle to drive up to and order food and drinks from said removably attached interactive computer terminal;
sending said order to said ambulatory food service vehicle;
routing said customer vehicle from said removably attached interactive computer terminal to an order pick-up window in said ambulatory food service vehicle with said adaptable drive though lane system; and
providing said order to said customer in said customer vehicle at said order pick-up window of said ambulatory food service vehicle.
   36. The method of providing mobile food services as described in clause 35 or any other clause and further comprising a step of locating said removably attached interactive computer terminal on an opposite side from said order pick-up window of said ambulatory food service vehicle.
   37. The method of providing mobile food services as described in clause 35 or any other clause and further comprising a step of removing said removably attached interactive computer terminal from said ambulatory food service vehicle and placing said removably attached interactive computer terminal in a location away from said ambulatory food service vehicle.
   38. The method of providing mobile food services as described in clause 35 or any other clause and further comprising a step of placing a car barrier near said removably attached interactive computer terminal.
   39. The method of providing mobile food services as described in clause 35 or any other clause and further comprising a step of placing a car barrier near said order pick-up window.
   40. The method of providing mobile food services as described in clause 38 or 39 or any other clause wherein said car barrier comprises a portable post.
   41. The method of providing mobile food services as described in clause 35 or any other clause wherein said step of providing said removably attached interactive computer terminal on said ambulatory food service vehicle comprises a step of providing said removably attached interactive computer terminal in a cabinet on said ambulatory food service vehicle.
   42. The method of providing mobile food services as described in clause 35 or any other clause and further comprising a step of locating said removably attached interactive computer terminal on a same side as said order pick-up window of said ambulatory food service vehicle.
   43. The method of providing mobile food services as described in clause 35 or any other clause wherein said removably attached interactive computer terminal comprises a credit card terminal and an intercom.
   44. The method of providing mobile food services as described in clause 35 or any other clause and further comprising a step of providing a second interactive computer terminal.
   45. The method of providing mobile food services as described in clause 35 or any other clause and further comprising a step of providing a remote ordering system for said ambulatory food service vehicle.
   46. The method of providing mobile food services as described in clause 45 or any other clause and further comprising a step of allowing a customer to place an order from said remote ordering system using a web-based application and providing an order code to said customer to be entered at said removably attached interactive computer terminal.
   47. The method of providing mobile food services as described in clause 35 or any other clause wherein said adaptable drive though lane system comprises placing cones near said ambulatory food service vehicle to guide customer vehicles.
   48. The method of providing mobile food services as described in claim 35 or any other clause wherein said adaptable drive through lane comprises a U-turn lane from said removably attached interactive computer terminal to said order pick-up window.
   49. The method of providing mobile food services as described in clause 35 or any other clause and further comprising providing an order pick-up time is less than about three minutes from a time an order is placed from said removably attached interactive computer terminal to the time an order is ready at said order pick-up window.
   50. The method of providing mobile food services as described in clause 35 or any other clause and further comprising a step of moving said removably attached interactive computer terminal closer to said customer vehicle with a movable robotic arm connected to said removably attached interactive computer terminal.
   51. The method of providing mobile food services as described in clause 50 or any other clause and further comprising a step of auto-retracting said removably attached interactive computer terminal with said movable robotic arm.
   52. The method of providing mobile food services as described in clause 50 or any other clause and further comprising a step of auto-sensing a customer vehicle arrival to move said removably attached interactive computer terminal with said movable robotic arm.
   53. The method of providing mobile food services as described in clause 35 or any other clause and further comprising a step of providing a security system.
   54. The method of providing mobile food services as described in clause 53 or any other clause wherein said security system comprises exterior and interior security cameras.
   55. The method of providing mobile food services as described in clause 35 or any other clause and further comprising a step of providing a contactless sliding drawer at said order pick-up window.
   56. The method of providing mobile food services as described in clause 35 or any other clause and further comprising a step of providing a sanitizing system in said ambulatory food service vehicle.
   57. The method of providing mobile food services as described in clause 56 or any other clause wherein said sanitization system comprises a sanitizing mist.
   58. The method of providing mobile food services as described in clause 57 or any other clause and further comprising a step of sanitizing food packages containing said food.
   59. The method of providing mobile food services as described in clause 35 or any other clause and further comprising a step of providing a power supply to said ambulatory food service vehicle chosen from externally mounted propane tanks and rechargeable batteries.
   60. The method of providing mobile food services as described in clause 35 or any other clause wherein said ambulatory food service vehicle has an internal space of about 8 feet wide by about 24 feet long.
   61. The method of providing mobile food services as described in clause 35 or any other clause wherein said ambulatory food service vehicle comprises a bathroom.
   62. The method of providing mobile food services as described in clause 35 or any other clause wherein said food prepared in said ambulatory food service vehicle comprises food prepared at a restaurant and distributed to said ambulatory food service vehicle.
   63. The method of providing mobile food services as described in claim 62 or any other clause wherein said food prepared in said ambulatory food service vehicle has been previously frozen and thawed.
   64. The method of providing mobile food services as described in clause 62 or any other clause wherein said food prepared in said ambulatory food service vehicle comprises best selling food from said restaurant.
   65. The method of providing mobile food services as described in clause 35 or any other clause wherein said ambulatory food service vehicle comprises an element chosen from a range, griddle, fryer, steam table, refrigerator, freezer, refrigerated preparation station, water heater, hand wash station, towel dispenser, sink, soap dispenser, water tank fill port, water tank drain, worktop table, countertops with cabinets below, vent hood with a fire suppression system, thermostat, flood lights, power cable, power circuits, propane tanks, propane fill port, propane flow regulator, and any combination or permutation thereof.
   66. The method of providing mobile food services as described in clause 35 or any other clause wherein said ambulatory food service vehicle comprises an interior curb side layout from a front of a vehicle to a back of a vehicle: a hand wash sink in a bathroom, a 19 cubic foot refrigerator, a 19 cubic foot freezer, a 4 pan steam table, a 30 inch by 10 foot exhaust hood with filters and a grease trap, two fryers, a 24 inch griddle on a 24 inch by 30 inch equipment stand, a 36 inch 6-burner stove with oven, a 24 inch by 24 inch preparation table with an undershelf, a 30 gallon holding tank for a kitchen under said vehicle, a curb side waste outlet with separate gate valves for each tank located under said vehicle, and a 30 gallon holding tank for a bathroom located under said vehicle.
   67. The method of providing mobile food services as described in clause 35 or any other clause wherein said ambulatory food service vehicle comprises an interior street side layout from a back of a vehicle to a front: an 84 inch service window; 84 inch counter with cabinets below; a 36 inch refrigerated sandwich prep station; a hand wash station with a cabinet below; a three bay sink with drain boards with cabinets below; a bi-fold bathroom door; and a porcelain RV toilet.
   68. The method of providing mobile food services as described in clause 35 or any other clause wherein said order pick-up window comprises an 84 inch service window with two manual open, self-close sections.

As can be easily understood from the foregoing, the basic concepts of the present invention may be embodied in a variety of ways. It involves both food vehicle drive through techniques as well as devices to accomplish the appropriate mobile food vehicle drive through. In this application, the mobile food vehicle techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives. For example, to the extent ultimately used, the existence or non-existence of a substance or condition in a particular input, output, or at a particular stage can be specified as substantially only x or substantially free of x, as a value of about x, or such other similar language. Using percentage values as one example, these types of terms should be understood as encompassing the options of percentage values that include 99.5%, 99%, 97%, 95%, 92% or even 90% of the specified value or relative condition; correspondingly for values at the other end of the spectrum (e.g., substantially free of x, these should be understood as encompassing the options of percentage values that include not more than 0.5%, 1%, 3%, 5%, 8% or even 10% of the specified value or relative condition, all whether by volume or by weight as either may be specified. In context, these should be understood by a person of ordinary skill as being disclosed and included whether in an absolute value sense or in valuing one set of or substance as compared to the value of a second set of or substance. Again, these are implicitly included in this disclosure and should (and, it is believed, would) be understood to a person of ordinary skill in this field. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of an “order” should be understood to encompass disclosure of the act of “ordering”—whether explicitly discussed or not—and, conversely, were there effectively disclosure of the act of “ordering”, such a disclosure should be understood to encompass disclosure of an “order” and even a “means for ordering.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of below listing of reference or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

### U.S Patents

| | | Kind | | |
|---|---|---|---|---|
| No. | Patent No. | Code | Issue Date | Patentee |
| 1 | 8,622,453 | B1 | 2014 Jan. 7 | Karapetian Jr. |
| 2 | 4,601,509 | | 1986 Jul. 22 | Ellis, Sr. |
| 3 | 4,675,515 | | 1987 Jun. 23 | Lucero |
| 4 | 5,921,036 | | 1999 Jul. 13 | Murphy |
| 5 | 6,366,220 | B1 | 2002 Apr. 2 | Elliott |
| 6 | 6,409,186 | B2 | 2002 Jun. 25 | Bennington |
| 7 | 6,547,133 | B1 | 2003 Apr. 15 | DeVries, Jr. et al. |
| 8 | 8,037,969 | B2 | 2011 Oct. 18 | Curt et al. |
| 9 | 9,221,401 | B1 | 2015 Dec. 29 | Birkenstock |
| 10 | 10,041,264 | B2 | 2018 Aug. 7 | Olsen |
| 11 | 10,489,869 | B2 | 2019 Nov. 26 | Peterson |

### U.S. Patent Application Publications

| | Publication | Kind | | |
|---|---|---|---|---|
| No. | No. | Code | Issue Date | Patentee |
| 1 | 20050236387 | A1 | 2005 Oct. 27 | Stockley |
| 2 | 20130024299 | A1 | 2013 Jan. 24 | Wong et al. |
| 3 | 20130197949 | A1 | 2013 Aug. 1 | Dermer et al. |
| 4 | 20140060342 | A1 | 2014 Mar. 6 | Russell |
| 5 | 20150088779 | A1 | 2015 Mar. 26 | Falcone et al. |
| 6 | 20160014220 | A1 | 2016 Jan. 14 | Kim |
| 7 | 20170058543 | A1 | 2017 Mar. 2 | Olsen |
| 8 | 20170115009 | A1 | 2017 Apr. 27 | Ramphos et al. |
| 9 | 20190318319 | A1 | 2019 Oct. 17 | Blackburn |

### Foreign Patent Documents

| | Foreign | | | | |
|---|---|---|---|---|---|
| | Document | Country | Kind | Publication | Name of |
| No. | Number | Code | Code | Date | Patentee |
| 1 | 8705425 | WO | | 1987 Sep. 11 | Lucero |
| 2 | 0197206 | WO | A1 | 2001 Dec. 20 | Johndrow & Nord |
| 3 | 2016006882 | WO | A1 | 2016 Jan. 14 | Kim |

### Non-Patent Literature Documents

| No. | Non-Patent Literature Document |
|---|---|
| 1 | DIAZ, ANN-CHRISTINE, This Mobile McDonald's |
| | Drive-Thru Puts Other Food Trucks to Shame: |
| | The Golden Arches Just Leveled Up Its Fast Food Game, |
| | www.adage.com/creativity/work/drive-thruck/51915, |
| | 2017 May 31, 4 pages |
| 2 | Fully Loaded Food Trailer With Bathroom: |
| | Freedom/Freedom/2015, www.roaminghunger.com/ |
| | marketplace/buy-a-food-truck/1687-2015-Freedom- |
| | Freedom-fully-loaded-food-trailer-with-BATHROOM/, |
| | 2015, 4 pages |
| 3 | Drive Through Window (2), www.concessionnation.com/ |
| | gallery_pop_up/16ft-food-truck-yayos-omg-2/drive- |
| | through-window-2/, 2018, 5 pages |

Thus, the applicant(s) should be understood to have support to claim and make a statement of invention to at least: i) each of the mobile trailer devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

In addition and as to computer aspects and each aspect amenable to programming or other electronic automation, it should be understood that in characterizing these and all other aspects of the invention—whether characterized as a device, a capability, an element, or otherwise, because all of these can be implemented via software, hardware, or even firmware structures as set up for a general purpose computer, a programmed chip or chipset, an ASIC, application specific controller, subroutine, or other known programmable or circuit specific structure—it should be understood that all such aspects are at least defined by structures including, as person of ordinary skill in the art would well recognize: hardware circuitry, firmware, programmed application specific components, and even a general purpose computer programmed to accomplish the identified aspect. For such items implemented by programmable features, the applicant(s) should be understood to have support to claim and make a statement of invention to at least: xv) processes performed with the aid of or on a computer, machine, or computing machine as described throughout the above discussion, xvi) a programmable apparatus as described throughout the above discussion, xvii) a computer readable memory encoded with data to direct a computer comprising means or elements which function as described throughout the above discussion, xviii) a computer, machine, or computing machine configured as herein disclosed and described, xix) individual or combined subroutines and programs as herein disclosed and described, xx) a carrier medium carrying computer readable code for control of a computer to carry out separately each and every individual and combined method described herein or in any claim, xxi) a computer program to perform separately each and every individual and combined method disclosed, xxii) a computer program containing all and each combination of means for performing each and every individual and combined step disclosed, xxiii) a storage medium storing each computer program disclosed, xxiv) a signal carrying a computer program disclosed, xxv) a processor executing instructions that act to achieve the steps and activities detailed, xxvi) circuitry configurations (including configurations of transistors, gates, and the like) that act to sequence and/or cause actions as detailed, xxvii) computer readable medium(s) storing instructions to execute the steps and cause activities detailed, xxviii) the related methods disclosed and described, xxix) similar, equivalent, and even implicit variations of each of these systems and methods, xxx) those alternative designs which accomplish each of the functions shown as are disclosed and described, xxxi) those alternative designs and methods which accomplish each of the functions shown as are implicit to accomplish that which is disclosed and described, xxxii) each feature, component, and step shown as separate and independent inventions, and xxxiii) the various combinations of each of the above and of any aspect, all without limiting other aspects in addition.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1-68. (canceled)

69. A food service system comprising:
an ambulatory food service vehicle having a food and drink preparation station;
a mobile self-standing interactive computer terminal configured for customer ordering of food and drinks from said ambulatory food service vehicle; and
an order pick-up window in said ambulatory food service vehicle.

70. The food service system as described in claim 69 and further comprising a cabinet located on an external side of said ambulatory food service vehicle configured to contain said mobile self-standing interactive computer terminal.

71. The food service system as described in claim 69 and further comprising a contactless sliding drawer at said order pick-up window

72. The food service system as described in claim 69 and further comprising a sanitization system in said ambulatory food service vehicle comprising a sanitizing mist.

73. The food service system as described in claim 69 and further comprising a sanitization system in said ambulatory food service vehicle comprising sanitization of the food package.

74. The food service system as described in claim 69 and further comprising an adaptable drive though lane system configured to route customer vehicles to said mobile self-standing interactive computer terminal and thereafter to said order pick-up window of said ambulatory food service vehicle.

75. The food service system as described in claim 69 wherein said mobile self-standing interactive computer terminal is placed in a location away from said ambulatory food service vehicle.

76. The food service system as described in claim 69 wherein said mobile self-standing interactive computer terminal comprises a credit card terminal and an intercom.

77. The food service system as described in claim 69 and further comprising a second interactive computer terminal.

78. The food service system as described in claim 69 and further comprising a remote ordering system.

79. The food service system as described in claim 78 wherein said remote ordering system comprises a web-based application and an order code to be entered at said mobile self-standing interactive computer terminal.

80. The food service system as described in claim 74 wherein said adaptable drive though lane system comprises cones placed to guide customer vehicles.

81. The food service system as described in claim 80 wherein said adaptable drive through lane comprises a U-turn lane from said mobile self-standing interactive computer terminal to said order pick-up window.

82. The food service system as described in claim 69 and further comprising a movable robotic arm connected to said mobile self-standing interactive computer terminal configured to move said mobile self-standing interactive computer terminal closer to said customer vehicle.

83. The food service system as described in claim 82 wherein said movable robotic arm comprises an auto-retraction feature.

84. The food service system as described in claim 82 wherein said movable robotic arm comprises an auto-sense customer vehicle arrival feature.

85. The food service system as described in claim 69 and further comprising a security system.

86. The food service system as described in claim 85 wherein said security system comprises exterior and interior security cameras.

87. The food service system as described in claim 69 wherein said mobile self-standing interactive computer terminal comprises a kiosk.

88. The food service system as described in claim 69 wherein said mobile self-standing interactive computer terminal is configured to support walk up customers
